(19) United States
(12) Patent Application Publication
(10) Pub. No.: US 2022/0315689 A1
(43) Pub. Date: Oct. 6, 2022

(54) Rapid Synthesis of Polyaldehydes

(71) Applicant: Georgia Tech Research Corporation, Atlanta, GA (US)

(72) Inventors: Paul A. Kohl, Atlanta, GA (US); Anthony Engler, Atlanta, GA (US)

(21) Appl. No.: 17/633,646

(22) PCT Filed: Aug. 10, 2020
(86) PCT No.: PCT/US2020/045591

§ 371 Date: Feb. 8, 2022

Related U.S. Application Data
(60) Provisional application No. 62/884,775, filed on Aug. 9, 2019.

(51) Int. Cl. C08G 6/00; B01J 19/24

(52) U.S. Cl. CPC C08G 6/00; B01J 19/24; B01J 2219/00164

(57) ABSTRACT

The present disclosure relates to depolymerizable poly(aldehydes) and systems and methods of efficiently synthesizing the same. An exemplary method of making a polymer comprises continuously flowing a polymerization solution through at least a portion of a reactor, and generating a poly(aldehyde) polymer from the polymerization solution.

### CROSS-REFERENCE TO RELATED APPLICATIONS

This application claims the benefit of U.S. Provisional Application No. 62/884,775, filed Aug. 9, 2019, and entitled “Rapid Synthesis of Polyaldehydes,” which is incorporated by reference herein in its entirety.

### STATEMENT REGARDING GOVERNMENT SPONSORED RESEARCH

This invention was made with government support under Award Nos. 1906BYD/GR10001685 awarded by the Department of Defense. The government has certain rights in the invention.

### FIELD OF DISCLOSURE

The present disclosure relates to depolymerizable poly(aldehydes) and systems and methods of efficiently synthesizing the same.

### BACKGROUND

Depolymerizable polymers are of interest for engineering applications, especially when their decomposition products can be recycled back into high value monomers. Such “low ceiling temperature” polymers are of growing interest for their facile ability to depolymerize back into high value monomers that can improve chemical recycling efforts, and help address the global problem of plastic waste accumulation. The ceiling temperature (T_{C}) describes the temperature where polymerization and depolymerization rates are equal for a given condition. Above T_{C}, the polymer is thermodynamically driven to depolymerize from active centers back into its constituent monomers. Without active centers (i.e. a kinetically inert polymer chain), the polymer is metastable above T_{C} and therefore usable until depolymerization is chemically, thermally, mechanically, or photolitically induced.

Low ceiling temperature polymers are of value for applications where it is favorable to have the polymer depolymerize back into constituent small molecule monomers. Example applications include degradable electronic sensors, semiconductor manufacturing processes, and recyclable polymers. The benefit of having polymers with ceiling temperatures (T_{C}) below ambient conditions is that it helps to drive the depolymerization back to monomers, due to the fact that the monomer is the thermodynamically favored state above T_{C}. Polyaldehydes have been shown to have low ceiling temperatures, often below room temperature. The synthesis of the polymer is under cryogenic conditions, well below room temperature, to push the equilibrium of the reaction in favor of the polymer. The yield and polymer properties improve as the synthesis temperature drops well below the ceiling temperature. Once synthesized, the polymer can exist in a metastable state above its T_{C} as long as the active chain ends are properly terminated or removed. Stabilization can be accomplished by end-capping the polymer with more stable chemical compounds, or by making cyclic polymers (i.e. no chain ends). To ensure long shelf-life of these metastable materials, it is imperative to thoroughly remove any impurities which may cause the production of an active chain end.

o-Phthalaldehyde (o-PHA), T_{C}=−35° C., is a versatile monomer that can be ionically polymerized or copolymerized with aldehydes and alkenes to create a variety of functional, depolymerizable materials. Polyphthalaldehyde (PPHA) and its derivatives form cyclic polymer products which can depolymerize rapidly from the solid state. Polyphthalaldehyde and its derivatives have been shown to be promising materials for probe-based lithography and other stimuli-responsive applications due to their ability to rapidly depolymerize from the solid-state polymer. The cationic polymerization route to PPHA is often preferred over the anionic route because the polymer has a longer shelf-life and higher molecular weight that improves the mechanical properties of the resulting material. The anionic route provides lower dispersity and greater synthetic control with the opportunity to utilize functional endcaps. The cationic polymerization mechanism for PPHA is able to produce high molecular weight and in the form of a cyclic polymer with improved shelf-life.

Other polyaldehydes and copolymers made from two or more aldehydes can also be used. Different aldehydes which may contain different functional groups can give the polymer new physical and chemical properties including high vapor pressure when depolymerized or the ability to undergo subsequent reactions such as cross-linking. There are many applications for transient structural compounds including disposable delivery vehicles, transient sensors, disappearing adhesive tape, and temporary protective materials. The addition of a comonomer may enhance the mission-specific properties of the polyaldehyde.

The currently known methods of synthesizing such low ceiling temperature polymers utilize batch processing. A critical goal in the synthesis is to obtain high molecular weight polymers and to remove the catalyst and other species after polymerization. High molecular weight polymer helps to improve the mechanical properties, which is vital for applications where the polymer serves as a structural material.

Several issues exist with the currently known batch process syntheses of low ceiling temperature polymers, including polyphthalaldehyde and its copolymers. One problem with running the polymerization in a batch process is that as the molecular weight increases during the reaction, the viscosity of the medium becomes large and the polymerization reaction becomes mass transport limited. In the viscous reaction medium, the diffusion of unreacted monomers to active chain sites becomes slow which slows the growth in molecular weight of the polymer and slows the uptake of monomer into the polymer (also known as monomer conversion efficiency). Accordingly, batch process polymerization takes hours to days. Batch processes also limit how fast the reactor can be cooled due to the surface area contacting the coolant (large batch reactors tend to have small surface area-to-volume ratios which means cooling can take a long time). The slower heat transfer rate of large batch processes also suppress the reaction rate due to self-heating from the exothermic nature of the polymerization reaction. An additional disadvantage of a batch process is that batch reactors require a separate quenching step (to terminate polymerization) followed by a separate precipitation step to purify the polymer.

### SUMMARY

The present disclosure provide systems and methods for making a polymer. An exemplary method of making a polymer comprises: (a) continuously flowing a polymerization solution through at least a portion of a reactor; and (b) generating a poly(aldehyde) polymer from the polymerization solution.

In any of the embodiments disclosed herein, a temperature of the at least a portion of the reactor can be from about 0° C. to about −110° C.

In any of the embodiments disclosed herein, the temperature of the at least a portion of the reactor can be about −80° C.

In any of the embodiments disclosed herein, continuously flowing the polymerization solution can occur at a pressure of from about 1 to about 100 bar.

In any of the embodiments disclosed herein, the method can produce a monomer to polymer conversion rate of from about 10% to about 99%.

Another embodiment of the present disclosure provides a continuous flow reactor. The reactor can comprise one or more inlets, a continuous flow reactor channel, and one or more outlets. The one or more inlets can be configured to receive one or more components of a polymerization solution. The continuous flow reactor channel can be configured to: (i) receive the polymerization solution; (ii) continuously flow the polymerization solution through the continuous flow reactor channel; and (iii) generate a poly(aldehyde) polymer. The one or more outlets can be in fluid communication with the continuous flow reactor channel. The one or more outlets can be configured to output the poly(aldehyde) polymer.

In any of the embodiments disclosed herein, the continuous flow reactor can further comprise a cooling unit configured to maintain at least a portion of the continuous flow reactor channel at a temperature of between about 0° C. and −100° C.

In any of the embodiments disclosed herein, the continuous flow reactor can further comprise a cooling unit configured to maintain at least a portion of the continuous flow reactor channel at a temperature of about −80° C.

In any of the embodiments disclosed herein, the reactor can be configured to continuously flow the polymerization solution through the continuous flow reactor channel at a pressure of from about 1 bar to 100 bar.

In any of the embodiments disclosed herein, the continuous flow reactor can be configured to produce a monomer to polymer conversion rate of from about 10% to about 99%.

In any of the embodiments disclosed herein, the continuous flow reactor channel comprises a reaction line having an internal diameter of from about 10 μm to about 1000 μm.

In any of the embodiments disclosed herein, the continuous flow reactor channel comprises a reaction line having a volume of from about 1 μL to about 5000 μL.

In any of the embodiments disclosed herein, the continuous flow reactor channel comprises a reaction line having an interfacial surface area of from about 100 m⁻¹ to about 20000 m⁻¹.

Another embodiment of the present disclosure provides a method of making a polymer comprising: (a) continuously flowing a polymerization solution through a first inlet of a continuous flow reactor, the polymerization solution comprising o-PHA, and BF3OEt2; (b) continuously flowing a quencher solution through a second inlet of the continuous flow reactor, the quencher solution comprising pyridine; and (c) generating cyclic poly(phthalaldehyde).

In any of the embodiments disclosed herein, the poly(aldehyde) polymer can be cyclic.

In any of the embodiments disclosed herein, the poly(aldehyde) polymer can be poly(phthalaldehyde).

In any of the embodiments disclosed herein, the poly(phthalaldehyde) can be cyclic.

In any of the embodiments disclosed herein, the poly(aldehyde) polymer can have a number average molecular weight of from about 1 kDa to about 1,000 kDa.

In any of the embodiments disclosed herein, the poly(aldehyde) polymer can be a copolymer.

In any of the embodiments disclosed herein, the poly(aldehyde) polymer can be a copolymer of poly(phthalaldehyde) and a second aldehyde.

In any of the embodiments disclosed herein, the second aldehyde can be an aliphatic aldehyde.

In any of the embodiments disclosed herein, the polymerization solution can comprise a first monomer and a catalyst.

In any of the embodiments disclosed herein, the first monomer can be selected from the group consisting of phthalaldehyde and a derivative thereof.

In any of the embodiments disclosed herein, the first monomer can be phthalaldehyde.

In any of the embodiments disclosed herein, the catalyst can be selected from the group consisting of BF₃OEt₂, gallium (III) chloride, and tin (IV) chloride.

In any of the embodiments disclosed herein, the catalyst can be BF₃OEt₂.

In any of the embodiments disclosed herein, the polymerization solution can further comprise a second monomer.

In any of the embodiments disclosed herein, the second monomer can be an aldehyde.

In any of the embodiments disclosed herein, the aldehyde can be an aliphatic aldehyde.

In any of the embodiments disclosed herein, the polymerization solution can further comprise a solvent.

In any of the embodiments disclosed herein, the solvent can be selected from the group consisting of dichloromethane, chloroform, toluene, and combinations thereof.

In any of the embodiments disclosed herein, the solvent can be dichloromethane.

In any of the embodiments disclosed herein, the polymerization solution can further comprise a quencher.

In any of the embodiments disclosed herein, the quencher can be selected from the group consisting of pyridine, amines, and Lewis bases.

In any of the embodiments disclosed herein, the quencher can be pyridine.

In any of the embodiments disclosed herein, the polymerization solution can be substantially homogenous.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings

FIG. 1 shows a plot of the conversion of phthalaldehyde into poly(phthalaldehyde) in accordance with an embodiment of the disclosure.

FIG. 2 shows small batch polymerization conversion-time plot for BF₃OEt₂ injected at −78° C. (●), and room temperature 3 min prior to cooling (▴), with [M]₀=0.746 M and [M]₀/[I]₀=500, in accordance with an embodiment of the disclosure.

FIG. 3 shows an exemplary continuous flow reactor in accordance with an embodiment of the disclosure.

FIGS. 4A and 4B shows: (a) First-order time-conversion plot for different catalyst loadings. Grey plot areas and dashed lines refer to chain fusion regime; and (b) Mn-conversion profiles, with [M]₀/[I]₀=500 (♦), 300 (▴), 160 (●), 50 (▪) for both plots, in accordance with an embodiment of the disclosure.

FIG. 5 shows bilogarithamic plot of apparent rate constants, kapp, for chain growth (▴) and chain fusion (●) versus the catalyst concentration, [BF3OEt2], in accordance with an embodiment of the disclosure.

FIG. 6 shows first-order time-conversion plot for polymerizations conducted at −78° C. (●), −67° C. (♦), −57° C. (▪); [M]₀/[I]₀=160 for all runs, in accordance with an embodiment of the disclosure.

FIG. 7 shows Proposed Mechanism of Reversible, Chain Transfer Reactions Leading to Intramolecular Chain Pinching (Forward Reaction), and Intermolecular Chain Fusion (Reverse Reaction), in accordance with an embodiment of the disclosure.

FIG. 8 shows apparent rate constants versus temperature for cationic polymerization of o-PHA using BF₃OEt₂ catalyst, in accordance with an embodiment of the disclosure.

### DETAILED DESCRIPTION

The present disclosure relates to methods of efficiently synthesizing low ceiling temperature polymers, including polyaldehydes, utilizing continuous flow processing. The disclosed processes can advantageously allow the polymerization reaction to proceed to high molecular weight and high monomer conversion on time scales that are much faster than known syntheses, e.g., syntheses that utilize batch processes. In certain embodiments, the continuous flow process is a pressure-driven flow process. Such pressure-driven flow can lead to improved mixing of the monomers and catalyst in the reaction solution which can lead to increased homogeneity and consistency of the polymerization mixture and resulting polymer. Without wishing to be bound by theory, it is thought that such improved mixing can result is the facile and fast production of high molecular weight polymers because the diffusion-limited rate is overcome by using higher mass transport.

The disclosed processes, which can utilize a continuous-flow reactor, can advantageously reduce the diffusion length, that is, reduce the length that the monomer must diffuse to reach an active reaction site on the polymer, thus allowing more facile monomer conversion. Moreover, the disclosed processes can allow for a high reactor surface-to-volume ratio which improves the heat transfer rate allowing for rapid cooling of the reactants. Rapid cooling of the reactants can allow for the polymerization reaction to start without a long induction period waiting for the reaction mixture to cool. Accordingly, the disclosed processes advantageously reduce the induction period, allowing for a faster polymerization reaction to occur.

Another benefit of performing the polymerization according to the disclosed processes herein is the ability to combine several unit operations into one continuous process. For example, the quenching agent can advantageously be introduced via a micro-mixer in the reactor line, which can then be fed into a non-solvent bath for the precipitation and purification of the polymer. Thus, time, equipment and money are saved with the multi-step continuous flow processes disclosed herein.

In certain embodiments, disclosed herein is a method of making a polymer comprising: (a) continuously flowing a polymerization solution through at least a portion of a reactor, and (b) generating a poly(aldehyde) polymer from the polymerization solution.

The polymerization solution can comprise various components necessary for the polymerization reaction to proceed under the desired conditions. In certain embodiments, the polymerization solution comprises one or more monomers and a catalyst. In certain embodiments, the polymerization solution further comprises a quencher solution. In certain embodiments, the polymerization solution further comprises a solvent. In certain embodiments, the polymerization solution comprises a first monomer, a second monomer, a catalyst, a solvent, and a quencher solution. The polymerization solution can be added to the continuous flow reactor as a single solution comprising all of the required components, or alternatively, the components can be added to the reactor separately. In certain embodiments, the one or more monomers, catalyst, and solvent are added to the continuous flow reactor separately from the quencher solution, which can be added after the polymerization reaction has been allowed to proceed for the desired amount of time in the continuous flow reactor.

In certain embodiments, the polymerization reaction occurs at a temperature of from about 20° C. to about −110° C. Accordingly, in certain embodiments, the temperature of at least a portion of the reactor is from about −40° C. to about −90° C.

In certain embodiments, the polymerization reaction occurs under pressure. In certain embodiments, the reaction occurs at a pressure of from about 1 bar to about 100 bar. More specifically, in certain embodiments, the reaction occurs at a pressure of from about 1 bar to about 10 bar.

A person of ordinary skill in the art would understand that the disclosed polymers are formed from reacting their corresponding monomers with an appropriate catalyst and/or initiator to induce a chain-growth polymerization. In certain embodiments, the poly(aldehyde) is formed from a single monomer. In certain embodiments, the poly(aldehyde) is a copolymer formed from at least two distinct monomers. In certain embodiments, the first and second monomers are both aldehydes. Such aldehyde monomers include, but are not limited to, o-phthalaldehyde (o-PHA), linear aldehydes, branched aldehydes, alkyl aldehydes, halogenated aldehydes, and aldehydes containing, oxygen, nitrogen, phosphorous, sulfur or silicon atoms. In certain embodiments, the monomer is o-phthalaldehyde (o-PHA). In certain embodiments, the first monomer is o-phthalaldehyde (o-PHA) and the second monomer is an aliphatic aldehyde.

In certain embodiments, the poly(aldehyde) formed from the above-described monomers is poly(phthalaldehyde) (PPHA). In certain embodiments, the poly(aldehyde) is poly(phthalaldehyde) (PPHA). In certain embodiments, the poly(aldehyde) polymer is a cyclic polymer. In certain embodiments, the poly(aldehyde) polymer is a linear polymer.

In certain embodiments, the polymer molecular weight is from about 1,000 Daltons to about 1,000,000 Daltons. The polymer molecular weights disclosed herein are number average molecular weights (Mn) as determined by the GPC methods disclosed in the Example herein.

In certain embodiments, the poly(aldehydes) formed from the methods disclosed herein are low ceiling temperature polymers. In certain embodiments, the ceiling temperature of the poly(aldehyde) is from about −80° C. to about 30° C.

In certain embodiments, the catalyst is a cationic, or anionic catalyst. In certain embodiments, the catalyst is a cationic catalyst. In certain embodiments, the cationic catalyst is selected from boron trifluoride diethyl etherate (BF₃OEt), and other Lewis acids such as tin (IV) chloride (e.g., tin tetrachloride) and gallium (III) chloride (e.g., gallium trichloride). Anionic catalysts include metal alkoxides, amines, phosphazene bases, and organolithium reagents.

In certain embodiments, the polymerization reaction occurs in an appropriate solvent. Accordingly, in certain embodiments, the polymerization solution comprises a solvent. In certain embodiments, the solvent is selected from the group consisting of dichloromethane, toluene, pentane, chloroform, or combinations thereof.

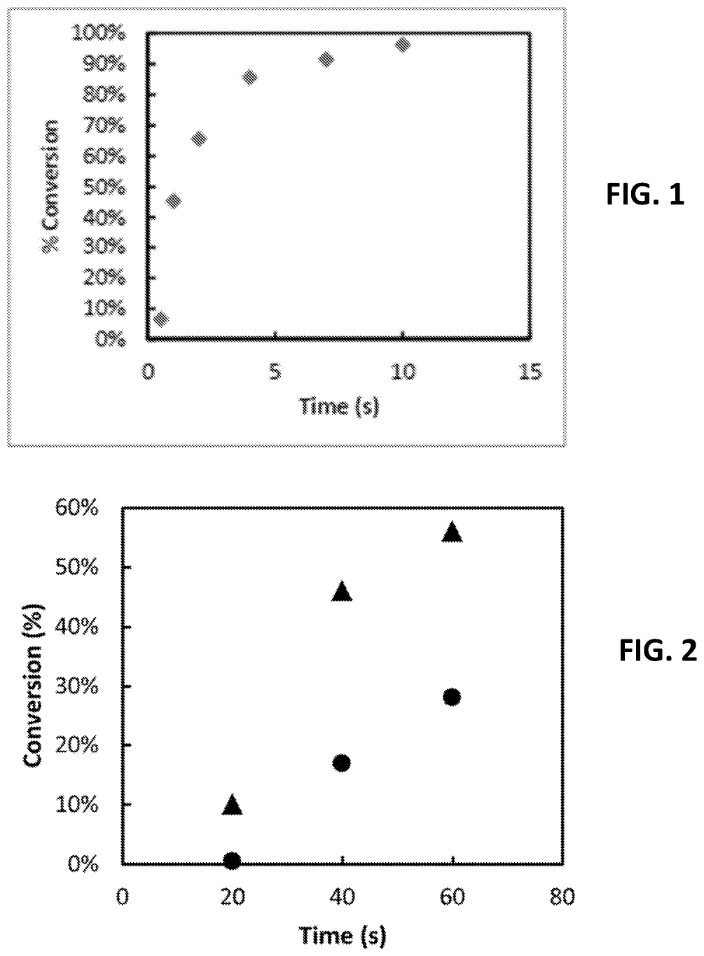

In certain embodiments, the polymerization reaction is allowed to proceed for an appropriate amount of time to reach the desired polymer molecular weight. In certain embodiments, the polymerization reaction time is from about 1 second to about 10 minutes. In certain embodiments, the polymerization reaction time is from about 1 second to about 7 minutes, from about 1 second to about 5 minutes, from about 1 second to about 3 minutes, from about 1 second to about 2 minutes, from about 1 second to about 60 seconds, from about 1 second to about 45 seconds, from about 1 second to about 30 seconds, from about 1 second to about 20 seconds, or from about 1 second to about 10 seconds. In certain embodiments, the polymerization reaction time is from about 5 seconds to about 60 seconds, from about 5 seconds to about 45 seconds, from about 5 seconds to about 30 seconds, from about 5 seconds to about 20 seconds, or from about 5 seconds to about 10 seconds. In certain embodiments, the reaction time is about 10 seconds. FIG. 1 shows a reaction time of 10 seconds according to the methods disclosed herein. As used herein “reaction time” refers to the time from polymerization initiation to the point at which the polymerization is quenched or terminated. Reaction time in this figure corresponds to the total time the reaction mixture is in the reaction zone/channel of the reactor. In certain embodiments, the polymerization conversion rate of monomer to polymer is from about 10% to about 99%.

In certain embodiments, a quencher can be added to the continuous flow reactor to stop the polymerization reaction after the desired amount of time. In certain embodiments, the quencher is selected from pyridine, aliphatic amines, and Lewis bases. In certain embodiments, the quencher can be added in the form of a quencher solution that comprises the quencher and an appropriate quencher solvent. Such quencher solvent can be selected from dichloromethane, toluene, tetrahydrofuran (THF), and the like. The disclosure, however, is not so limited. Rather, any “good solvent,” i.e., a solvent that solubilizes the polymer, can be used.

One advantage of the methods described herein is the ability to form reproducible, homogenous polymerization solutions. Accordingly, in certain embodiments, the polymerization solution is substantially homogenous. “Substantially homogenous” as used herein refers to the entire polymerization volume being exposed to substantially the same mass and heat transfer conditions so that a similar quality of polymer is formed throughout the entire volume. Although some polymerization systems are run in what may appear to be a homogeneous reactor (i.e., only one phase exists in the system), however, ‘hot spots’ can form in a batch reactor where there is slow mass/heat transfer. These hot spots can lead to different reaction rates and qualities of polymer product.

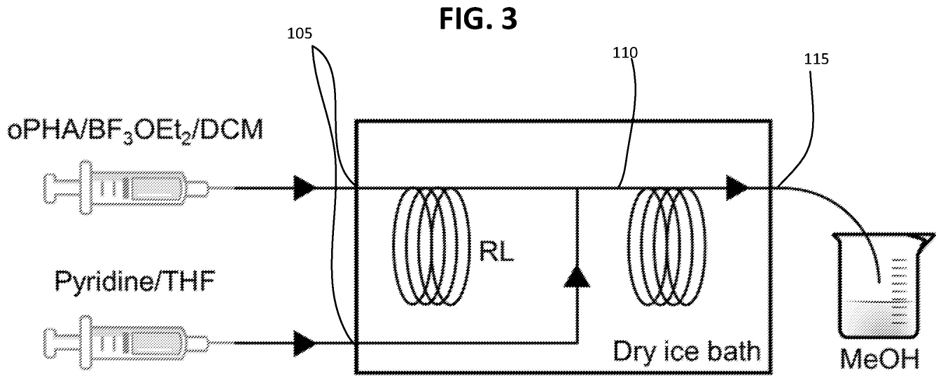

In certain embodiments, the methods disclosed herein are carried out in a continuous flow reactor. FIG. 3 provides a schematic of an exemplary continuous flow reactor. As shown in FIG. 3, the continuous flow reactor can one or more inlets 105 configured to receive one or more components of a polymerization solution. The continuous flow reactor can further comprise a continuous flow reactor channel 110 configured to: (i) receive the polymerization solution, (ii) continuously flow the polymerization solution through the continuous flow reactor channel 110 and (iii) generate a poly(aldehyde) polymer. The continuous flow reactor can further comprise one or more outlets 115 in fluid communication with the continuous flow reactor channel. The one or more outlets can be configured to output the poly(aldehyde) polymer. The continuous flow reactor can further comprise a cooling unit configured to maintain at least a portion of the continuous flow reactor channel 110 at a temperature of between about −90° C. and about 0° C. The cooling unit can be many different cooling units known in the art, including, but not limited to, ice (e.g., dry ice), a refrigeration unit, a chiller, and the like. In certain embodiments, the continuous flow reactor is configured to continuously flow the polymerization solution through the continuous flow reactor channel 110 at the desired pressure and produce the desired monomer to polymer conversion rate.

In certain embodiments, the continuous flow reactor channel 110 can comprise a reaction line having an internal diameter of from about 10 μm to about 1 cm. In certain embodiments, the continuous flow reactor channel 110 can comprise a reaction line having a volume of from about 1 μL to about 5000 μL. In certain embodiments, the continuous flow reactor channel 110 can comprise a reaction line having an interfacial surface area of from about 100 m⁻¹ to about 20000 M⁻¹. It is noted that continuous reactor described herein can be scaled up to larger volumes by building parallel continuous flow reactor channels. Building a second channel would double the throughput of the reactor system. Many channels in parallel can used to synthesize polymer at a faster rate while maintaining the benefits of small flow reactors. It is also noted that the single channel reactor can be further modified in terms of length, diameter and flow rate (via higher or lower pressure driven flow) to optimize the yield and polymer production rate. Accordingly, in certain embodiments, the surface-to-volume ratio of the continuous flow reactor can be from 1000 m⁻¹ to 10,000 m⁻¹.

It is to be understood that wherever values and ranges are provided herein, all values and ranges encompassed by these values and ranges, are meant to be encompassed within the scope of the present application. Moreover, all values that fall within these ranges, as well as the upper or lower limits of a range of values, are also contemplated by the present application.

The following examples further illustrate aspects of the present application. However, they are in no way a limitation of the teachings or disclosure of the present application as set forth herein.

### Example

A microflow reactor was used to examine the cationic polymerization of o-phthalaldehyde with boron trifluoride diethyl etherate as the polymerization catalyst. High molecular weight polymer, >270 kDa, was formed in 10 seconds. Kinetic and molecular weight data indicate that two polymerization regimes exist. The first regime is characterized by controlled growth rates to moderate molecular weight polymers. The second regime occurs above a threshold concentration where intermolecular chain transfer dominates the polymerization kinetics, resulting in an exponential growth of the polymer molecular weight via fusion of adjacent polymer chains. A ring-expansion polymerization model is proposed to explain these polymerization results. These findings enable greater synthetic control to achieve targeted polymer properties for poly(aldehydes), and identifies kinetic methods that can be employed to assess the activity of other polymerization catalysts.

Experimental Details.

Unless otherwise stated, all starting materials were obtained from commercial suppliers and used without further purification. Anhydrous dichloromethane (DCM) was purchased from EMD Millipore. ACS grade tetrahydrofuran (THF) and methanol (MeOH) were purchased from BDH Chemicals. o-Phthalaldehyde, >99.7%, was purchased from TCI and used as-received. Boron trifluoride diethyl etherate, ca. 48% BF₃, was purchased from Acros Organics. Pyridine, 99%, was purchased from Alfa Aesar. Dry ice and acetone or isopropyl alcohol were used to create the −78° C. bath. Frozen MeOH/water mixtures with dry ice were used to target −57° C. and −67° C. baths. Temperatures of these baths were constantly monitored via thermocouple and observed variations of ±1.5° C. from the reported value.

Stainless steel (316 grade) piping and connections were purchased from Swagelok. PTFE tubing and luer-lock adapters were purchased from Hamilton and used to connect the syringes to the stainless-steel pipe. Flexible PDMS tubing was purchased from McMaster-Carr and used as the outlet of the reactor that dripped into the MeOH precipitation flask. A model PHD 2000 syringe pump was purchased from Harvard Apparatus.

Gel permeation chromatography (GPC) analyses were measured on a system composed of Shimadzu GPC units (DGU-20A, LC-20AD, CTO-20A, and RID-20A) utilizing a refractive index detector and a Shodex column (KF-805L) with HPLC grade THF (1 mL/min flow rate at 30° C.) as the eluent. The GPC was calibrated using a series of linear, monodisperse polystyrene standards from Shodex.

Apparent rate constants were calculated by performing linear least squares regression to obtain slope values from the first-order time-conversion plot. The reported uncertainty in these values was taken as the standard error of the slope.

Batch Polymerizations. All glassware was cleaned several times with DCM and dried in a 150° C. oven overnight prior to use. Reactions were prepared in a glovebox under a nitrogen atmosphere maintained at <0.1 ppm H₂O and <100 ppm O₂. To a 100 mL round bottom flask was added a desired amount of o-PHA. Anhydrous DCM was added to bring the total monomer concentration to 0.746 M, accounting for the volume of the catalyst solution added later. This stock solution was partitioned into separate vials, each containing an equivalent mass of 0.25 g o-PHA. A dilute catalyst solution was prepared in a separate 20 mL vial with stock BF₃OEt₂ and anhydrous DCM. A volume of 0.1 mL of this solution was added to the reaction vial via syringe. Polymerizations were run at −78° C. with the use of dry ice and acetone inside of a VWR Symphony Ultrasonic Cleaner (model 97043-992, at an operating frequency of 35 kHz and power density of 36 mW/cm³). Pyridine, 0.2 mL, was injected to quench the polymerization after the desired length of time. The reaction was allowed to mix with pyridine for 2 min before being precipitated dropwise into vigorously stirred MeOH. The precipitation bath was stirred for >1 hour before filtering and allowing the white solid polymer to air dry overnight.

Flow Polymerizations: Glassware and reaction preparation was the same as in batch experiments. Experimental runs were performed on a 0.50 g basis of o-PHA monomer in solution. After addition of catalyst to the vial, the polymerization solution was taken-up in an Air-Tite syringe, removed from the glovebox and transported to a fumehood where the reactor was stationed. The needle cap was quickly swapped out for the reactor adapter, and the syringe was loaded into the pump. A previously prepared syringe of equal volume containing 20% v/v pyridine in THF was loaded into the second slot of the pump. The syringe pump was operated at specific flow rates to control the residence time (T_{R}) in the reactor before mixing with the quenching stream. The time between adding the catalyst in the glovebox and starting the run in the reactor was 4 min. The output of the reactor fed into a vigorously stirred MeOH bath to precipitate the polymer and purify it from the unreacted monomer. Conversion was taken as the gravimetric yield of dry polymer.

Results.

Initiation. The investigation of PPHA polymerization kinetics began with small batch experiments using an ultrasonic bath to enhance mixing of the solution because high molecular weight PPHA solutions become sufficiently viscous during polymerization to stop a magnetic stir bar. The initial experiments involved injecting the catalyst into the monomer solution cooled to −78° C. However, this procedure required an induction period of about 20 sec and resulted in 28% conversion in 60 s (FIG. 2). Without wishing to be bound the theory, long induction periods could be attributed to the time required for catalyst to associate with monomer and form stable cyclic polymers, or might suggest that BF₃OEt₂ is not the true polymerization initiator. Without wishing being bound by theory, it is thought that BF₃OEt₂ alone may be unable to initiate aldehyde and acetal polymerizations and required a cation co-catalyst, such as adventitious water or aldehyde hydrate. This slow initiation helps explain higher molar mass dispersity values obtained from cationic PPHA synthesis (small kᵢ/kₚ ratio), with values here ranging from 2.13 to 2.30. To overcome the slow initiation, experiments were performed by injecting BF₃OEt₂ into the reaction mixture at room temperature to increase the fraction of catalyst molecules that are active for polymerization. Higher temperatures increase the initiation rate of the true active catalyst, and monomer propagation is negligible due to the dominance of the depropagation reaction on systems above T_{C}. Addition of BF₃OEt₂ several minutes prior to cooling the reaction mixture below T_{C} has shown to have little effect on the final PPHA products.¹⁸ Catalyst conditioning increased the polymerization rate by about a factor of two, reaching 56% conversion in 60 s. Additionally, the molar mass dispersity values were slightly lower from 1.96 to 2.00, presumably due to increasing the value of the kᵢ/kₚ ratio. After measuring the cooling rate of the polymerization mixture via an in-situ thermocouple, it became evident that the reaction rate was limited by the cooling rate of the solution. Having identified limitations in mixing and cooling rates in the polymerization setup, a microflow reactor was used to more closely examine the kinetics.

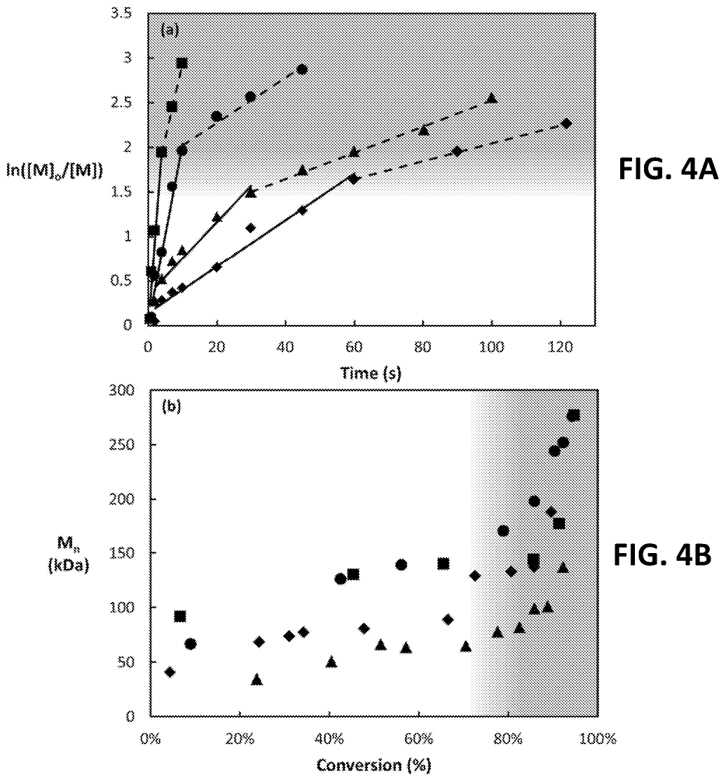

Molecular Weight Growth. A schematic of the flow reactor setup used in this study is given in FIG. 3. The compiled results of the kinetic experiments are given in Table 1. First-order time-conversion plots for four different initial monomer-to-catalyst loadings polymerized at −78° C. are shown in FIG. 4A. The slopes of the linear fits give the apparent rate constants for each run. It was found that there are two linear regimes for each set of experiments, with the transition between the two linear regimes occurring at 70 to 80% conversion. This transition approximately corresponds to a sudden increase in molecular weight. FIG. 4B shows an atypical S-curve trend of the molecular weight with conversion. Molecular weight evolution during the polymerization can give insight into the relative values of kₚ, kₜ, and k_{f} at a given condition. At low and moderate conversions, the molecular weight rapidly climbs followed by little additional growth while the creation of new chains accounts for the increasing conversion. This regime will subsequently be referred to as the chain ‘Growth’ regime. Mechanistically, this observation can be explained by propagation dominating the system at low conversion. That is, kₚ>>kₜ when the conversion<10% and the concentration of monomer is high. As the conversion grows beyond this early stage and the concentration of monomer decreases, gradual or minimal change in the molecular weight occurs as the conversion proceeds from 20 to 70%. This is explained by an increased rate of catalyst dissociation, kₜ. These free, active catalysts are able to initiate new chains without significantly affecting the average molecular weight, but continue to contribute to advancing the percent conversion.

TABLE 1
Kinetic results of cationic o-PHA polymerization using BF₃OEt₂
in a flow reactor.

| | | T | τ_{R,max} | Conversion | Mₙ @ | Ð @ | k_{app, Growth} | k_{app, Fusion} |
|---|---|---|---|---|---|---|---|---|
| Run | [M]₀/[I]₀ ^{a} | (° C.) | (s) | @ max | max ^{b} | max | (s⁻¹) | (s⁻¹) |
| 1 | 500 | −78 | 122 | 0.89 | 188 | 1.94 | 0.026 ± 0.002 | 0.0099 ± 0.0001 |
| 2 | 300 | −78 | 100 | 0.92 | 137 | 1.87 | 0.041 ± 0.005 | 0.0146 ± 0.0006 |
| 3 | 160 | −78 | 44.9 | 0.94 | 276 | 1.94 | 0.20 ± 0.02 | 0.025 ± 0.003 |
| 4 | 50 | −78 | 10.0 | 0.94 | 277 | 2.13 | 0.51 ± 0.06 | 0.167 ± 0.002 |
| 5 | 160 | −67 | 10.0 | 0.78 | 174 | 2.09 | 0.16 ± 0.03 | — |
| 6 | 160 | −57 | 7.00 | 0.56 | 120 | 2.15 | 0.13 ± 0.04 | — |

^{a} [M]₀ = 0.746M.
^{b} Number average molecular weight in kDa as determined by GPC.

After the kinetic transition near 75% conversion, the nominal value of Mn nearly doubles in the last 20% conversion, named the ‘Fusion’ regime. At this point, intermolecular chain transfer reactions begin to dominate the system as the monomer concentration becomes low and the concentration of polyacetal bonds become very high, effectively k_{f}>kₚ. The fusion of polymer chains via chain transfer accounts for the rapid, considerable growth of molecular weight, while the remaining monomer is more slowly consumed via propagation. It is suggested that over the evolution of this polymerization, a single catalyst molecule can be involved in initiation, propagation, and dissociation multiple times. This also supports the notion that the catalyst favors a dissociated state over complexation with a polymer chain. This phenomenon can lead to molecular weight growth profiles similar to that of step-growth polymerizations, as described by Xia et al. in their ring-expansion metathesis polymerization.

It should be noted that the equilibrium of the PPHA system does not permit the reaction to be run to full conversion at −78° C. Trials that produced polymers larger than 250 kDa created a high pressure drop that stalled the pump. Batch-to-batch variations in the molecular weights are conceivable due to the highly sensitive nature of aldehyde polymerizations to adventitious impurities. Efforts were made to mitigate this effect, such as overnight oven drying of glassware, but some variability likely exists between batches. The catalyst loading has a weakly positive trend with the observed molecular weights, but strongly affects the conversion rate. The position of the regime transition along the reaction coordinate seems minimally affected by the viscosity of the system, based on the similar conversion levels for kinetic transitions yet differing molecular weights for different [M]₀/[I]₀ loadings. Without wishing to be bound by theory, it is hypothesized that increasing the [M]₀ would shift the regime change earlier in the polymerization coordinate, because it would more quickly reach the critical value of k_{f}/kₚ>1.

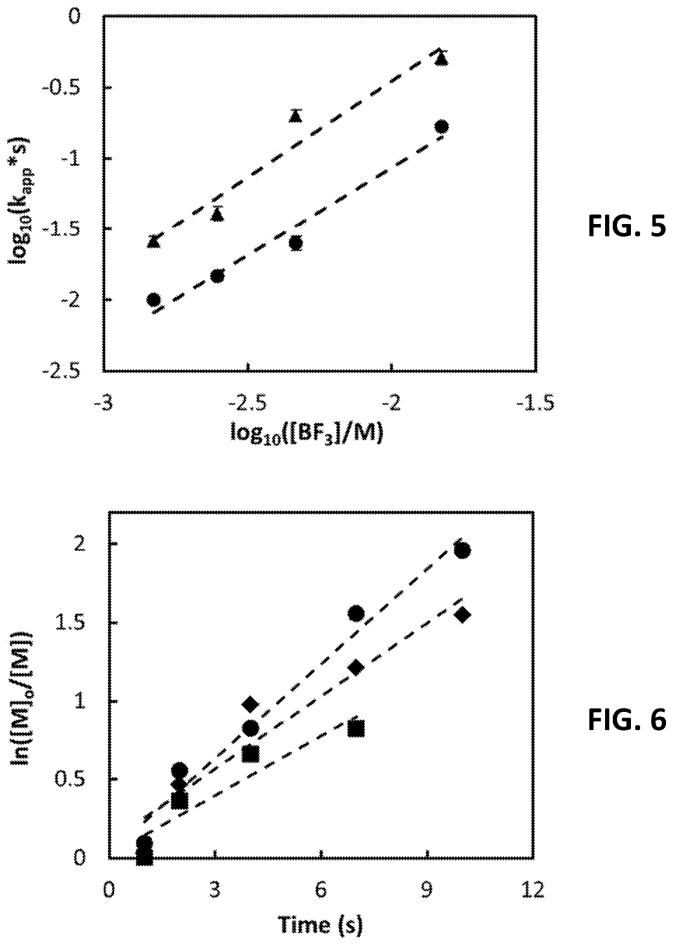

FIG. 5 shows the bilogarithamic plot of kₐₚₚ against [BF₃OEt₂], which results in a linear fit for both regimes. Chain growth regime follows a 1.36±0.23 order and chain fusion regime follows a 1.24±0.16 order with respect to the catalyst loading, taken from the slope of the lines. The fractional nature of the reaction order may arise from the complex, dynamic nature of the mechanism involved in the ring-expansion polymerization. The slopes of the lines are nearly equivalent within error, indicating the monomer is being consumed in the same mechanism, but at an overall slower rate due to competition of the active catalyst towards chain transfer reactions.

Temperature Effects. Additional experiments were performed at −57° C. and −67° C. to probe the temperature dependence of the rate constants and evaluate their predictive ability for the T_{C} of the system. First-order time-conversion plots indicate a slight downward curvature, (FIG. 6) possibly due to proximity of the system to the T_{C} that limits the equilibrium conversion. This is especially apparent at −57° C. where there is a plateau in conversion beyond the linear portion (see Supporting Information). This was also accompanied by an overall reduction in the molecular weight of the system from 120 kDa at the end of the linear portion to 69 kDa after 13 s of additional polymerization time. Once equilibrium conversion is attained between monomer and polymer, chain transfer reactions can lead to equilibration of the molecular weight in an attempt to reach the lowest possible thermodynamic energy state. Results here suggest that higher temperatures help promote intramolecular chain transfer (i.e. higher k_{-f}) via a polymer pinching reaction that results in lower molecular weight cyclic species. Under these conditions, polymer pinching is preferred over fusion due to the lower overall concentration of macromolecules, which promotes intra-over intermolecular reactions.

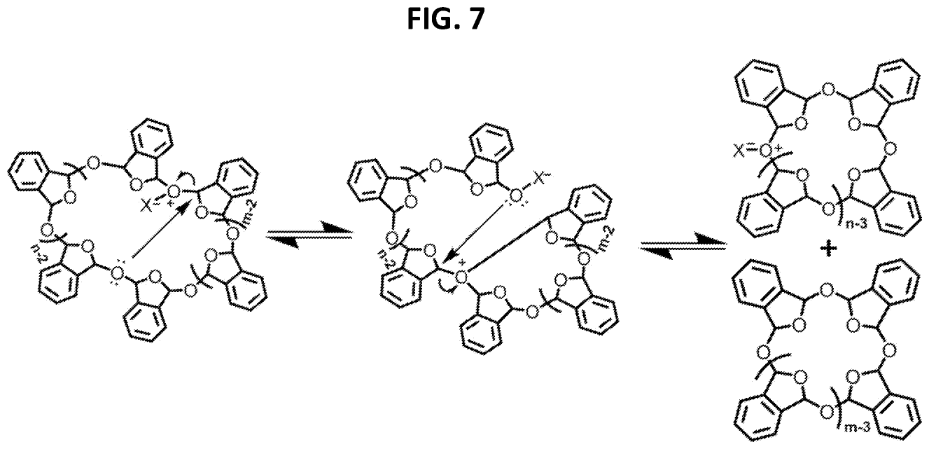

On the basis of these observations, we propose the following reversible, chain transfer mechanism that accounts for intermolecular chain fusion and intramolecular pinching phenomena (FIG. 7). The forward steps detail how a transacetalization reaction on an active, cyclic chain of n+m units long can pinch to produce two daughter chains, one of m units in length that is now kinetically inert, and one of n units in length that continues to be kinetically active. This transacetalization is capable of being initiated by any of the repeat units along the polymer chain that aren't sterically constrained. Likewise, the reverse reaction describes how two adjacent polymer chains can fuse into a single cyclic chain, giving rise to the exponential molecular weight growth observed late in the polymerization. FIG. 7 has been denoted with a generic cationic catalyst (X) because the exact form of active catalyst is has not been experimentally verified. An electrophilic zwitterionic ring-expansion mechanism with BF₃ forming a negative borate species, X⁻=—BF₃⁻, at the oxonium site is plausible. But given the evidence from alternative cationic catalysts promoting cationic propagation and the significant induction period observed here, the hypothesis that a complex ion, such as X⁻=—H(BF₃OH)⁻ formed through the reaction with adventitious water, is the true active catalyst cannot be ruled out. Such a catalyst may promote cyclization by maintaining a close proximity to the temporary hydroxyl chain end through hydrogen bonding with the complex anion.

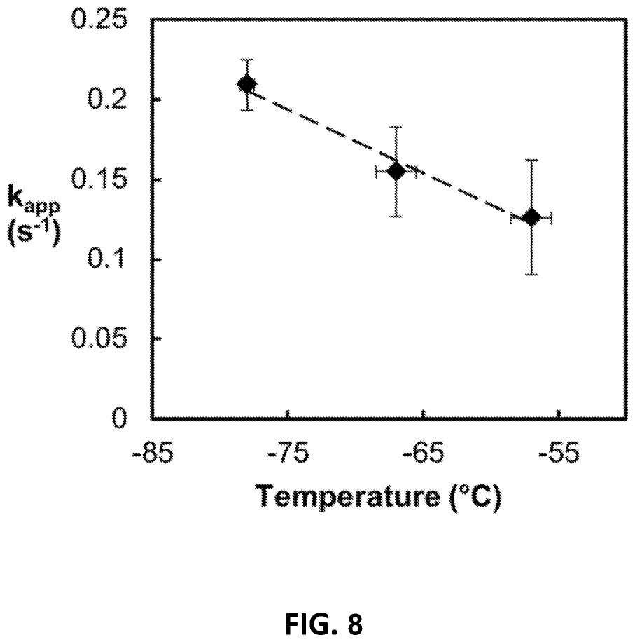

FIG. 8 shows kₐₚₚ versus temperature. Extrapolation of this line to kₐₚₚ=0 predicts that T_{C}=−27° C.±6° C. for this system, nearly in agreement with values cited in literature determined from equilibrium monomer concentration methods. As these kinetic methods are not as established as equilibrium monomer conversion studies, the overestimation of T_{C} relative to those results is likely due to phenomena that aren't being accounted for in the present analysis, such as thermal entrance effects and heat of reactions. Propagation rate should increase with temperature rather than following the anti-Arrhenius behavior shown here. The retardation shown in FIG. 8 for the polymerization kinetics as the temperature approaches T_{C} is due to the increasing dominance of the depropagation reaction (kₐₚₚ=kₚ−k_{d}[M]), which has been observed in other polymerization systems.³⁷ Cooling to lower temperatures would result in a maximum net polymerization rate. Further cooling to where the depropagation reaction becomes negligible would then show the expected Arrhenius type, apparent propagation rate constant. Pragmatic issues with this system, e.g. DCM freezing and the need for liquid nitrogen cryogens, make further investigation of these effects difficult.

Conclusions. The cationic polymerization kinetics of o-PHA using BF₃OEt₂ was investigated through small batch polymerizations and a microflow reactor system. Remarkably, reducing the system's resistance to mass and heat transfer that accompany batch polymerizations resulted in rapid kinetics, obtaining nominal molecular weights>270 kDa in 10 s with proper catalyst loadings. A ring-expansion polymerization mechanism was proposed to describe the observed kinetic and molecular weight data that supports an argument that two polymerization regimes exist. Specifically, the relative rates of initiation, propagation, catalyst dissociation, and chain transfer reactions determine the kinetically controlled molecular weight distribution. The propagation rate is high and catalysts are able to rapidly dissociate and form new chains in the first regime resulting in a plateau molecular weight profile up to 70 to 80% conversion. In the second regime, chain fusion rates begin to dominate propagation rates as the concentration of polymer becomes large, resulting in an exponential growth of the molecular weight due to intermolecular chain transfer.

1. A method of making a polymer comprising:
continuously flowing a polymerization solution through at least a portion of a reactor; and
generating a poly(aldehyde) polymer from the polymerization solution.

2. The method of claim 1, wherein a temperature of the at least a portion of the reactor is from about 0° C. to about −110° C.

3. The method of claim 1, wherein the temperature of the at least a portion of the reactor is about −80° C.

4. The method of claim 1, wherein the continuously flowing the polymerization solution occurs at a pressure of from about 1 to about 100 bar.

5. The method of claim 1, wherein the poly(aldehyde) polymer is cyclic.

6. The method of claim 1, wherein the poly(aldehyde) polymer is poly(phthalaldehyde).

7. (canceled)

8. The method of claim 1, wherein the poly(aldehyde) polymer has a number average molecular weight of from about 1 kDa to about 1,000 kDa.

9. The method of claim 1, wherein the poly(aldehyde) polymer is a copolymer.

10. The method of claim 9, wherein the poly(aldehyde) polymer is a copolymer of poly(phthalaldehyde) and a second aldehyde.

11. The method of claim 10, wherein the second aldehyde is an aliphatic aldehyde.

12. The method of claim 1, wherein the polymerization solution comprises a first monomer and a catalyst;
wherein the first monomer is selected from the group consisting of phthalaldehyde and a derivative thereof; and
wherein the catalyst is selected from the group consisting of BF3OEt2, gallium (III) chloride, and tin (IV) chloride.

13.-16. (canceled)

17. The method of claim 12, wherein the polymerization solution further comprises a second monomer.

18. The method of claim 17, wherein the second monomer is an aldehyde.

19. The method of claim 18, wherein the aldehyde is an aliphatic aldehyde.

20. The method of claim 12, wherein the polymerization solution further comprises a solvent;
wherein the solvent is selected from the group consisting of dichloromethane, chloroform, toluene, and combinations thereof.

21.-22. (canceled)

23. The method of claim 12, wherein the polymerization solution further comprises a quencher;
wherein the quencher is selected from the group consisting of pyridine, amines, and Lewis bases.

24.-25. (canceled)

26. The method of claim 1, wherein the polymerization solution is substantially homogenous.

27. The method of claim 1, wherein the method produces a monomer to polymer conversion rate of from about 10% to about 99%.

28. A continuous flow reactor comprising:
a continuous flow reactor channel configured to:
receive a polymerization solution;
continuously flow the polymerization solution through the continuous flow reactor channel; and
generate a poly(aldehyde) polymer;
wherein the reactor is configured to generate the poly(aldehyde) polymer in a polymerization reaction time of from about 1 second to about 10 minutes.

29. The continuous flow reactor of claim 28 further comprising a cooling unit configured to maintain at least a portion of the continuous flow reactor channel at a temperature of between about 0° C. and −100° C.

30. (canceled)

31. The continuous flow reactor of claim 28, wherein the reactor is further configured to continuously flow the polymerization solution through the continuous flow reactor channel at a pressure of from about 1 bar to 100 bar.

32.-53. (canceled)

54. The continuous flow reactor of claim 28, wherein the reactor is further configured to produce a monomer to polymer conversion rate of from about 10% to about 99%.

55. The continuous flow reactor of claim 28, wherein the continuous flow reactor channel comprises a reaction line having an internal diameter of from about 10 μm to about 1000 μm.

56. The continuous flow reactor of claim 28, wherein the continuous flow reactor channel comprises a reaction line having a volume of from about 1 μL to about 5000 μL.

57. The continuous flow reactor of claim 28, wherein the continuous flow reactor channel comprises a reaction line having an interfacial surface area of from about 100 m⁻¹ to about 20000 m⁻¹.

58. The method of of claim 1 further comprising:
continuously flowing a quencher solution through at least a portion of the reactor, the quencher solution comprising pyridine;
wherein the polymerization solution comprises o-PHA and BF3OEt2; and
wherein generating the poly(aldehyde) polymer from the polymerization solution comprises generating cyclic poly(phthalaldehyde) from the polymerization solution and the quencher solution.

59. The method of claim 1, wherein the reactor is configured to generate the poly(aldehyde) polymer in a polymerization reaction time of from about 1 second to about 10 minutes.

60. The method of claim 1, wherein the reactor is configured to generate the poly(aldehyde) polymer in a polymerization reaction time of from about 1 second to about 60 seconds.

61. A continuous flow reactor configured for the method of claim 1 comprising:
an inlet configured to receive the polymerization solution;
a continuous flow reactor channel in fluid communication with the inlet and configured to:
continuously flow the polymerization solution through the continuous flow reactor channel; and
generate the poly(aldehyde) polymer; and
an outlet in fluid communication with the continuous flow reactor channel and configured to output the poly(aldehyde) polymer.
